(19) United States
(12) Patent Application Publication
(10) Pub. No.: US 2020/0398739 A1
(43) Pub. Date: Dec. 24, 2020

(54) Back-Up Camera With Speaker and Lights

(71) Applicant: Process4, Inc., Chagrin Falls, OH (US)

(72) Inventor: Matthew Hanson, Chagrin Falls, OH (US)

(21) Appl. No.: 16/907,899

(22) Filed: Jun. 22, 2020

Related U.S. Application Data
(60) Provisional application No. 62/865,561, filed on Jun. 24, 2019.

(51) Int. Cl. B60Q 1/22; B60R 11/04; B60Q 5/00

(52) U.S. Cl. CPC B60Q 1/22; H04W 4/80; B60Q 5/005; B60R 11/04

(57) ABSTRACT

A backup-assisting device which assists in the backing up of a vehicle by providing one or more visual and auditory aids. The one or more visual and auditory aids include at least an image sensor such as digital video camera, one or more illuminating devices such as one or more lights, a sound-generating device such as speaker.

The present disclosure claims priority on U.S. Provisional Application Ser. No. 62/865,561 filed Jun. 24, 2019, which is incorporated herein by reference.

### BACKGROUND

The present disclosure sets forth a device which assists a driver in the backing up of a vehicle by providing one or more visual and auditory aids. However, it is to be appreciated that the present disclosure is also amenable to other like applications.

Existing aftermarket accessories for vehicles have provided individual devices such as audible alarms which audibly indicate that a vehicle is backing up, strobe lights which visually indicate that a vehicle is backing up and can also stay illuminated for better visibility, and cameras which visually capture and display the space behind a vehicle that is backing up.

It would be desirable to provide an improved aftermarket accessory which includes one or more auditory and visual components that operate synergistically in a single device.

### BRIEF DESCRIPTION

In accordance with one non-limiting aspect of the present disclosure, a backup-assisting device is described which is mounted on the vehicle at a desired location which backup-assisting device can be used to assist the driver in backing up a vehicle by providing one or more visual and auditory aids. The backup-assisting device is particularly useful for vehicles that do not have a rear camera system previously installed on the vehicle. The backup-assisting device can thus be used to create a back-up camera system on a vehicle that previously was absent such a back-up camera system. Also, the backup-assisting device is particularly useful for use on a trailer, boat, or other device being towed by a vehicle. Although a vehicle may include a preexisting back-up camera system, when a trailer, boat, or other device is being towed by a vehicle, such preexisting back-up camera can be partially or fully obstructed by the trailer, the boat, or other device being towed by the vehicle. The backup-assisting device in accordance with the present disclosure overcomes this problem by providing a device that can be easily connected to the vehicle or the trailer, the boat, or other device being towed by the vehicle to enable a user of the vehicle to see rearwardly of the vehicle and/or the trailer, the boat, or other device being towed by the vehicle. Although the backup-assisting device in accordance with the present disclosure is typically used when the vehicle is or is about to move in a reverse direction, it can be appreciated that the backup-assisting device can also be used when the vehicle is stationary or moving forward. As such, the backup-assisting device can be used to view objects that are rearwardly of the vehicle and/or rearwardly of the trailer, the boat, or other device being towed by the vehicle while the vehicle is stationary or moving.

In accordance with another non-limiting aspect of the present disclosure, there is provided a backup-assisting device that includes at least an image sensor (e.g., camera, charge-coupled device (CCD), active-pixel sensor (CMOS sensor), heat sensor, infrared sensor, etc.), an illuminating device (e.g., LED light, incandescent light, fluorescent light, halogen light, metal halide light, HPS light, LPS light, etc.), and a sound-generating device (e.g., speaker, etc.). The image sensor, illuminating device, and sound-generating device optionally operate synergistically to provide visual and auditory assistance for a driver when backing up a vehicle.

In accordance with another non-limiting aspect of the present disclosure, there is provided a backup-assisting device that includes a housing and an optional mounting arrangement. The housing is adapted for attachment to a vehicle. Each of the image sensor, illuminating device, and sound-generating device are connected to the housing and optionally are each partially enclosed within the housing. At least a portion of one or more of the image sensor, illuminating device, and sound-generating device are optionally located on the front face and/or surface of the housing.

In accordance with another non-limiting aspect of the present disclosure, there is provided a backup-assisting device that optionally includes a power source configured to power one or more of the image sensor, illuminating device, and sound-generating device that are connected to the housing. The power source can be located partially or fully within the housing. The power source can include one or more batteries (e.g., nickel-cadmium battery, nickel-metal hydride battery, lithium-ion battery, lead-acid battery, etc.) and/or a solar power source (solar panel, etc.). In one non-limiting embodiment, the housing includes a housing panel that is removable to enable a user to insert and replace one or more batteries in the housing. In such an arrangement, the one or more batteries are fully housed in the housing such that the housing partially or fully protects the one or more batteries from rain, dirt, and other adverse environmental elements and conditions during the use of the backup-assisting device. As can be appreciated, the backup-assisting device can optionally also or alternatively be connected to the electrical system of the vehicle to power one or more components of the backup-assisting device.

In accordance with another non-limiting aspect of the present disclosure, there is provided a backup-assisting device that includes a housing wherein the back side and/or bottom side of the housing are optionally substantially flat and optionally form an approximate right angle at the point where the two sides meet. Such a non-limiting arrangement can be used to facilitate in connecting the housing to a rear portion of a vehicle.

In accordance with another non-limiting aspect of the present disclosure, there is provided a backup-assisting device that includes a housing wherein the front face of the housing optionally includes a plurality of illuminating devices. In one non-limiting arrangement, one or more illuminating devices can be located at or near one side of the housing and one or more illuminating devices can be located at an opposite side of the housing. In another non-limiting arrangement, a plurality of illuminating devices are positioned in a vertical orientation with respect to one another. In another non-limiting arrangement, a plurality of illuminating devices are positioned in a vertical orientation with respect to one another to form a vertical stack of illuminating devices. In another non-limiting arrangement, a plurality of illuminating devices are positioned in a non-vertical orientation with respect to one another so as to form a curved or arced orientation of illuminating devices. When a plurality of illuminating devices are positioned at or near the sides of the housing, the same number of illuminating devices can be used on each side, and each illuminating device on one side can optionally correspond with the position of another illuminating device on the opposite side to create symmetry with regarding to pairs of illuminating devices on the housing. In another non-limiting arrangement, a portion of the sound-generating device and/or image sensor can optionally be located between two or more of the illuminating devices on the front of the housing. In one non-limiting configuration, a portion of the sound-generating device and/or image sensor is located on the central portion of the front of the housing and a plurality of illuminating devices are located on one side of the sound-generating device and/or image sensor and a plurality of illuminating devices are located on an opposite side of the sound-generating device and/or image sensor. In one non-limiting configuration, a portion of the sound-generating device is located below the image sensor on the front of the housing.

In accordance with another non-limiting aspect of the present disclosure, there is provided a backup-assisting device that includes a housing wherein the front face of the housing includes a sound-generating device that can be configured to optionally provide a one-way or two-way intercom for a person inside the vehicle to communicate with another person or persons located outside the vehicle to which the housing is connected thereto.

In accordance with another non-limiting aspect of the present disclosure, there is provided a backup-assisting device that includes an image sensor that (when activated) can capture images of the space and objects in the space which are located behind the vehicle and which would otherwise be blocked from the driver's view.

In accordance with another non-limiting aspect of the present disclosure, there is provided a backup-assisting device that includes one or more illuminating devices that (when activated) can be used to illuminate the space and objects in the space behind the vehicle so that the image sensor can provide a better picture and the driver can obtain a clearer view of the space and objects behind the vehicle.

In accordance with another non-limiting aspect of the present disclosure, there is provided a backup-assisting device that includes one or more illuminating devices that (when activated) can provide a visual warning to a person or persons at the rear of the vehicle that the vehicle is backing up or is about to back-up.

In accordance with another non-limiting aspect of the present disclosure, there is provided a backup-assisting device that includes a sound-generating device that (when activated) can optionally provide an audible sound or alarm which serves as an audible warning to a person or persons at the rear of the vehicle that the vehicle is in reverse or is about to reverse.

In accordance with another non-limiting aspect of the present disclosure, there is provided a backup-assisting device that optionally includes one or more proximity sensors (not shown) configured to activate the sound-generating device and/or one or more illuminating devices. The one or more proximity sensors (when used) can cause the sound-generating device to produce a certain sound or sound sequence (e.g., an increasing number of beeping sounds, change length of beeping sounds, change frequency of beeping sounds, etc.), and/or cause the one or more illuminating devices to illuminate or flash at certain sequence (e.g., flash every 0.01-10 seconds, etc.), and/or cause the one or more illuminating devices to illuminate at a certain color (e.g., red color, blue color, white color, yellow color, etc.) or produce a certain differing color sequence (e.g., red color, blue color, white color, yellow color, etc.) over a period of time (e.g., change color every 0.01-10 seconds, etc.). As can be appreciated, the plurality of illuminating devices can illuminate at the same or different times and/or illuminate at the same or different color.

In accordance with another non-limiting aspect of the present disclosure, there is provided a backup-assisting device that includes a housing that optionally includes a mounting arrangement integrally formed in the housing. The backup-assisting device can optionally include additional or alternative mounting arrangement such as, but not limited to, brackets and associated mounting hardware, magnets, adhesive strips, adhesive, hook and loop or similar fasteners, etc.

In accordance with another non-limiting aspect of the present disclosure, there is provided a backup-assisting device that includes circuitry configured to activate and control the one or more image sensors, one or more illuminating devices, and one or more sound-generating devices. The circuitry is optionally fully enclosed within the housing of the backup-assisting device so as to protect the circuitry from foreign objects such as dust, debris, moisture, light, etc., and/or from damage cause by undesired contract with the circuitry.

In accordance with another non-limiting aspect of the present disclosure, there is provided a backup-assisting device that includes circuitry that includes a central processing unit (CPU) configured to execute logic for controlling the image sensor, illuminating device, and/or sound-generating device.

In accordance with another non-limiting aspect of the present disclosure, there is provided a backup-assisting device that includes communication interface that may include a wireless transceiver and/or wired components and communications components capable of enabling data transmissions to and from the backup-assisting device.

In accordance with another non-limiting aspect of the present disclosure, there is provided a backup-assisting device that includes communication interface that can optionally send and receive data over a network which can be implemented through, for example, a wireless network such as a wireless local area network (WLAN), and/or the communication interface may alternatively send and receive data over physical wiring.

In accordance with another non-limiting aspect of the present disclosure, there is provided a backup-assisting device that can communicate with a communication interface in the vehicle. The communication interface in the vehicle can be configured to request, receive, modulate, and/or broadcast signals of the data with the backup-assisting device.

In accordance with another non-limiting aspect of the present disclosure, the vehicle includes a display device configured to show the driver of the vehicle images or representations thereof captured by the image sensor.

In one non-limiting object of the present disclosure, there is provided a backup-assisting device configured to be used with a vehicle to assist in the backing up of the vehicle.

In another non-limiting object of the present disclosure, there is provided a backup-assisting device comprising a housing, said housing having a front face and a mounting arrangement, said mounting arrangement configured to facilitate in attaching said housing to a rear of the vehicle; an image sensor, said image sensor configured to capture and/or record images, said image sensor at least partially located on said front face of said housing; an illuminating device, said illuminating device configured to generate light, said illuminating device at least partially located on said front face of said housing; a sound-generating device, said sound-generating device configured to generate sound, said sound-generating device at least partially located on said front face of said housing; and control circuitry at least partially located in an interior of said housing, said control circuitry including an image hardware/software module, a light hardware/software module, a sound hardware/software module, and a communication interface, said image hardware/software module configured to receive and/or output data that represents one or more images captured and/or recorded by said image sensor, said light hardware/software module configured to activate and/or control said one or more illuminating devices, said sound hardware/software module configured to activate and/or control said sound-generating device, said communication interface configured to send and/or receive data between a remote display and 1) said image hardware/software module, 2) said light hardware/software module, and/or 3) said sound hardware/software module.

In another non-limiting object of the present disclosure, there is provided a backup-assisting device wherein said mounting arrangement includes a first mounting flange on a first side of said housing and a second mounting flange on a second side of said housing, said first mounting flange including one or more opening adapted to receive a bolt, screw, or cord, said second mounting flange including one or more opening adapted to receive a bolt, screw, or cord.

In another non-limiting object of the present disclosure, there is provided a backup-assisting device wherein said illuminating device includes first and second sets of lights, said first set of lights includes a plurality of lights, said second set of lights includes a plurality of lights, at least a portion of said image sensor is located between said first and second sets of lights.

In another non-limiting object of the present disclosure, there is provided a backup-assisting device wherein said housing includes a removable back panel, said removable back panel providing access to a battery compartment in an interior of said housing.

In another non-limiting object of the present disclosure, there is provided a backup-assisting device wherein said communication interface includes a wireless transmitter and wireless receiver to wirelessly transmit data to and receive data from said remote display.

In another non-limiting object of the present disclosure, there is provided a backup-assisting system configured to be connected to a vehicle to assist in the backing up of the vehicle, said backup-assisting system comprising a backup-assisting device; and an external device located remotely of said housing of said backup-assisting device, said external device including a display that is configured to display images that were captured and/or recorded by said image sensor of said backup-assisting device, said external device including communication circuitry configured to received data from and/or transmit data to said communication interface communication interface of said backup-assisting device.

In another non-limiting object of the present disclosure, there is provided a backup-assisting system wherein said external device is a device selected from the group consisting of a smart phone, a tablet, a laptop computer, an integrated display in the front dashboard of the vehicle, and a free standing display.

In another non-limiting object of the present disclosure, there is provided a backup-assisting system wherein each of said communication interface and said external device include a separate wireless transmitter and wireless receiver to wirelessly transmit data to and receive data from said external device and said backup-assisting device.

In another non-limiting object of the present disclosure, there is provided a backup-assisting system wherein said control circuitry of said backup-assisting device is in communication with circuitry of the vehicle so that said control circuitry of said backup-assisting device is able to detect when said vehicle is moving in a reverse direction and/or has shifted into reverse gear, and wherein said control circuitry of said backup-assisting device is configured to activate said image sensor, said illuminating device, and/or said sound-generating device when said control circuitry of said backup-assisting device detects said vehicle moving in the reverse direction and/or has shifted into reverse gear. Such detection in direction can be by 1) GPS movement detection, 2) detection of direction of gear movement, and/or 3) detection of direction of tire rotation, etc.

In another non-limiting object of the present disclosure, there is provided a method for assisting a user of a vehicle in the backing up of said vehicle, said method comprising: 1) providing said vehicle, said vehicle having a rear portion; 2) providing a backup-assisting device; 3) providing an external device that is located remotely of said housing of said backup-assisting device, said external device including a display that is configured to display images that were captured and/or recorded by said image sensor of said backup-assisting device, said external device including communication circuitry configured to received data from and/or transmit data to said communication interface of said backup-assisting device; 4) connecting said housing of said backup-assisting device to said rear portion of said vehicle; 5) activating said backup-assisting device prior to, during, or after said vehicle is moving in the reverse direction or has shifted into reverse gear, said activating said backup-assisting device causing a) activation of said image sensor, and optional activation of said illuminating device and/or said sound-generating device, and b) transmission of data from said image sensor to said external device; and 6) displaying images on said display of said external device that are viewable in real-time by a user of said vehicle after said step of activating said backup-assisting device while said user is operating said vehicle.

In another non-limiting object of the present disclosure, there is provided a method for assisting a user of a vehicle in the backing up of said vehicle wherein said external device is a device selected from the group consisting of a smart phone, a tablet, a laptop computer, an integrated display in the front dashboard of the vehicle, and a free standing display.

In another non-limiting object of the present disclosure, there is provided a method for assisting a user of a vehicle in the backing up of said vehicle wherein each of said communication interface and said external device include a separate wireless transmitter and wireless receiver to wirelessly transmit data to and receive data from said external device and said backup-assisting device.

In another non-limiting object of the present disclosure, there is provided a method for assisting a user of a vehicle in the backing up of said vehicle wherein said control circuitry of said backup-assisting device is in communication with circuitry of the vehicle so that said control circuitry of said backup-assisting device is able to detect when said vehicle is moving in a reverse direction and/or has shifted into reverse gear, and wherein said control circuitry of said backup-assisting device is configured to activate said image sensor, said illuminating device, and/or said sound-generating device when said control circuitry of said backup-assisting device detects said vehicle moving in the reverse direction and/or has shifted into reverse gear.

In another non-limiting object of the present disclosure, there is provided a method for assisting a user of a vehicle in the backing up of said vehicle In another non-limiting object of the present disclosure, there is provided a method for assisting a user of a vehicle in the backing up of said vehicle wherein said external device includes a microphone to enable said user to speak into said microphone and to broadcast such speech through said sound-generating device of said backup-assisting device.

These and other aspects and advantages will become apparent from the following description taken together with the accompanying drawings.

### BRIEF DESCRIPTION OF THE DRAWINGS

Reference may now be made to the drawings, which illustrate various embodiments that the disclosure may take in physical form and in certain parts and arrangement of parts wherein:

FIG. 1 is an illustration according to one non-limiting embodiment of the present disclosure which illustrates the front view of a backup-assisting device to assist in the backing up of a vehicle;

FIG. 2 is a side plan view of the backup-assisting device in FIG. 1;

FIG. 3 is a back plan view of the backup-assisting device in FIG. 1;

FIG. 4 is a bottom plan view of the backup-assisting device in FIG. 1;

FIG. 5 is a bottom perspective view of the backup-assisting device in FIG. 1; and,

FIG. 6 is schematic illustration of the backup-assisting device in FIG. 1 showing a circuitry thereof being communicatively connected to a schematically illustrated circuitry of an associated vehicle.

### DETAILED DESCRIPTION OF NON-LIMITING EMBODIMENTS

A more complete understanding of the articles/devices, processes, and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 10% of the indicated number.

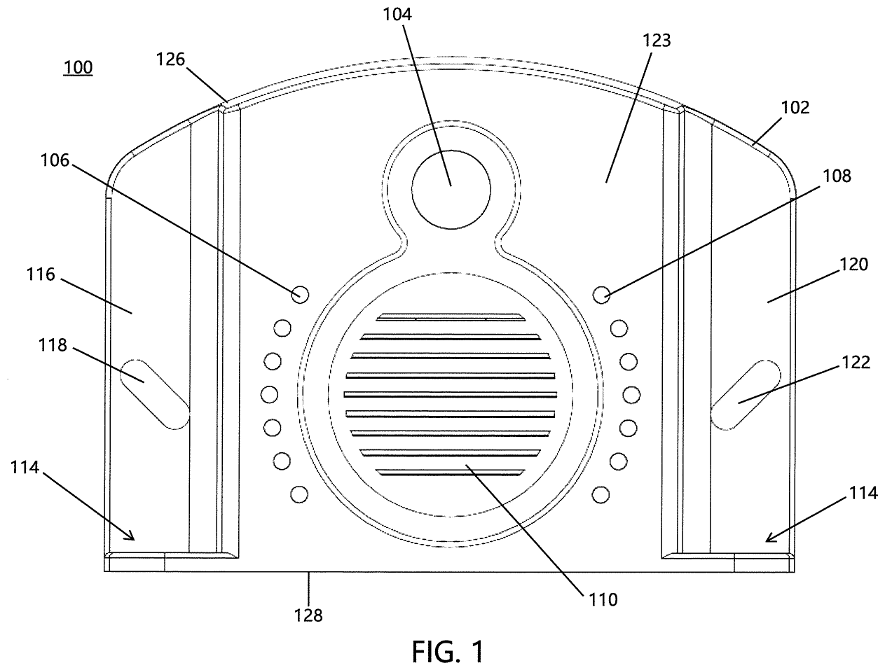

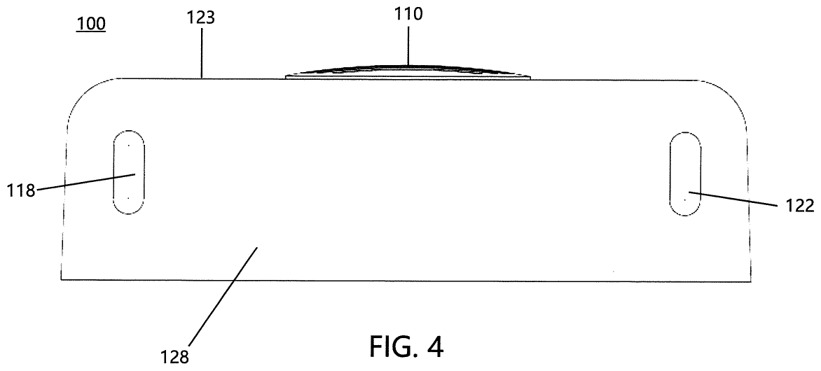

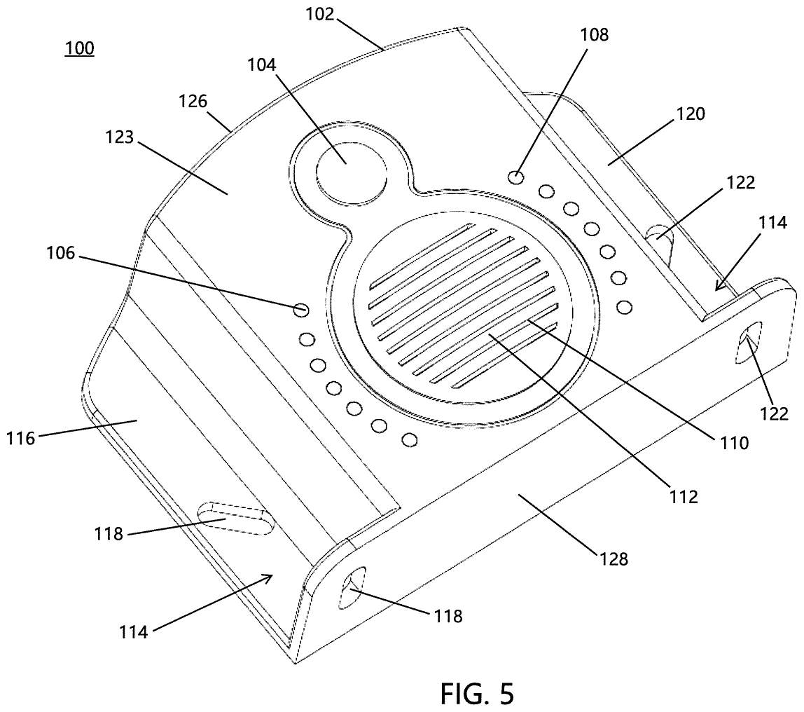

Referring now to the drawings, wherein the showings are for the purpose of illustrating non-limiting embodiments of the disclosure only and not for the purpose of limiting the same, FIGS. 1-6 illustrate various aspects of the backup-assisting device in accordance with the present disclosure. The backup-assisting device is configured to be an aftermarket accessory device which can be mounted to and used in an existing vehicle to assist a driver when backing up a vehicle by providing one or more visual and/or auditory aids.

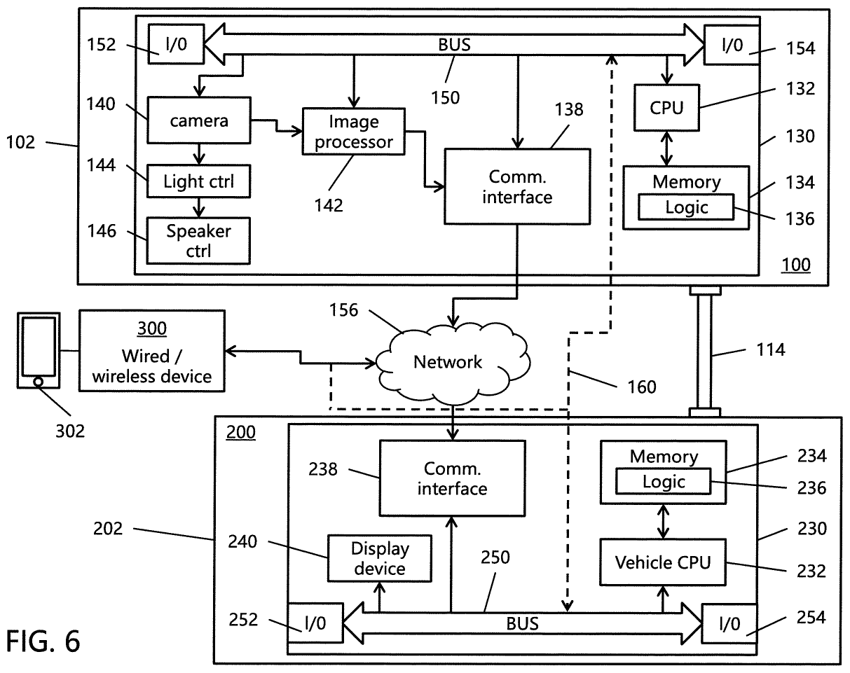

With reference to FIGS. 1-5, an exemplary backup-assisting device 100 is shown. The primary components of the backup-assisting device 100 include a housing 102, an image sensor 104 such as digital video camera, an illuminating device such as lights 106, 108, a sound-generating device 110 such as speaker, and a mounting arrangement 114. The housing 102 is adapted for attachment to an associated vehicle (e.g., car, truck, tractor, construction vehicles, lift vehicles, etc.), such as vehicle 200 schematically illustrated in FIG. 6.

Each of the image sensor 104, illuminating device 106, 108, and sound-generating device 110 are at least partially enclosed within the housing 102. The functioning portions of image sensor 104, illuminating device 106, 108, and sound-generating device 110 (e.g., the image sensor, camera lens, light bulb, and speaker cone) are generally located on a front side 123 of the housing. The respective back and bottom sides 124, 128 of the housing 102 are substantially flat and form an approximate right angle at the point where the two sides meet; however, this is not required. This right-angle arrangement may be useful when the housing 102 is mounted to a rear portion of the vehicle which forms a corresponding right angle, such as between the rear bumper and an adjacent body portion, for example; however, such an embodiment is non-limiting. Moreover, while a top side 126 of the housing is illustrated as a curved surface, such an embodiment is also non-limiting. The housing 102 of backup-assisting device 100 should generally be mounted to the vehicle such that the functioning portions of the image sensor 104, illuminating device 106, 108, and sound-generating device 110 face outward and away from the vehicle.

The image sensor 104 is shown as being centrally disposed on the front side 123 of the housing 102 and located at a position generally near the top side 126; however, such an arrangement is non-limiting. Moreover, while only a circular lens portion is illustrated to represent the image sensor 104, it should be understood that digital image sensors typically include a number of other known components which are not presently illustrated. For example, image sensors such as image sensor 104 generally include one or more types of sensors configured to convert light into an electrical signal. Some non-limiting types of sensors which may be employed by image sensor 104 include a charge-coupled device (CCD) or a complementary metal oxide semiconductor (CMOS).

The illuminating device is shown as including a first side light set 106 and a second side light set 108 located on either side of the image sensor 104 and sound-generating device 110, with each light set generally including a plurality of illuminating bulbs. However, it should be understood that any number of lights and bulbs can be included and positioned at any desired location on the backup-assisting device 100 without departing from the scope of the present disclosure. The specific type of bulbs making up first and second side light sets 106, 108 is non-limiting, but may include incandescent, halogen, fluorescent, compact fluorescent, high intensity discharge (HID), and other commonly known light bulb types. In some embodiments, light emitting diode (LED) are preferably used for the first and second side light sets 106,108.

The sound-generating device 110 is shown as being centrally disposed on the front side 123 of the housing 102 and located at a position generally under the image sensor 104; however, such an arrangement is non-limiting. The sound-generating device 110 can be any type of device known for converting electrical audio signals into a corresponding sound. In some embodiments, the sound-generating device 110 may be configured to provide a one-way or two-way intercom for communicating with a person or persons outside of the associated vehicle. The sound-generating device 110 may further include a grille 112 for protecting internal components while allowing sound to pass clearly therethrough. Optionally, the front side 123 of the housing 102 can include one or more slots that function as an alternative grill 112 for the sound-generating device 110.

The space and objects in the space located behind the rear portion of a vehicle are typically obscured by the vehicle body, such that a driver of the vehicle has a limited field of view or a blind spot behind the vehicle. When the backup-assisting device 100 of the present disclosure is mounted to the rear of the vehicle, the image sensor 104 (when activated) can capture images of the space and objects in the space which are located behind the vehicle and which would otherwise be blocked from the driver's view.

In addition, the first and second side light sets 106,108 (when activated) illuminate the space and objects in the space behind the vehicle so that the image sensor 104 can record a better picture and the driver can obtain a clearer view. Moreover, when the first and/or second side light sets 106,108 are activated, the illumination thereof also serves as a warning to a person or persons at the rear of the vehicle that the vehicle is backing up or is about to back-up. When one or more of the bulbs of the first and/or second side light sets 106,108 are lit, the one or more bulbs can be caused to flash and/or change colors to provide additional visual warning to persons behind the vehicle.

Further, the sound-generating device 110 (when activated) produces an audible sound and/or alarm which also serves as a warning to a person or persons at the rear of the vehicle that the vehicle is in reverse or is about to reverse. When the sound-generating device 110 is configured as a one-way or two-way intercom, the sound-generating device 110 is activated for the driver or passenger in the vehicle to communicate with a person or persons outside the vehicle. Moreover, in some embodiments, the sound-generating device 110 can include one or more additional proximity sensors (not shown) configured to activate the speaker and produce a changing sound. The changing sound (e.g., an increasing number of beeping sounds) is indicative of the proximity of an object located behind the rear of the vehicle.

The mounting arrangement 114 is illustrated as being integrally formed in the housing 102. However, such an embodiment is non-limiting and other mounting means could also be used without departing from the scope of the present disclosure. For example, the backup-assisting device could use brackets and associated mounting hardware which are supplied separate from the housing. Also or alternatively, the backup-assisting device could use one or more magnets, adhesive, hook and loop fasteners, etc., to facilitate in the mounting of the backup-assisting device to the vehicle.

The mounting arrangement 114 includes first and second side brackets 116, 120 formed on the left and right sides of the housing 102, such that the image sensor 104, first and second side light sets 106, 108, and sound-generating device 110 are disposed between the first and second brackets. The brackets 116, 120 are shown as having a general “L” shape; however, such an arrangement is non-limiting. One or more thru-holes 118/122 are optionally formed in the first and second side brackets 116, 120, respectively, and are adapted to receive hardware components (e.g., nuts and bolts, not shown) so that the housing 102 can be mounted to the associated vehicle.

The mounting arrangement 114 can optionally be made moveable such that the image sensor 104, first and second side light sets 106, 108, and sound-generating device 110 can be positioned as desired on the rear of the vehicle. Moreover, the mounting arrangement 114 can be configured to enable the housing 102 to be attached and detached from one portion of the associated vehicle and be reattached to another portion of the vehicle or a different vehicle altogether. For example, the housing could be reattached to a trailer being pulled by the vehicle or a load riding on the vehicle or trailer. However, such an embodiment is non-limiting. As can be appreciated, the housing 102 can be connected to other areas of the vehicle (e.g., front of vehicle, hood of vehicle, side of vehicle, etc.).

Referring now to FIG. 6, a schematic block diagram of the backup-assisting device 100 and a schematic block diagram of the vehicle 200 are illustrated as being communicatively connected to one another. In addition, the housing 102 of backup-assisting device 100 is shown as being physically connected to a body portion 202 of the vehicle 200 by mounting arrangement 114, as discussed in further detail above.

The backup-assisting device 100 as illustrated in FIG. 6 includes circuitry 130 configured to activate and control the image sensor 104, first and second side light sets 106, 108, and sound-generating device 110. The circuitry 130 is generally fully enclosed within the housing 102 to protect it from foreign objects such as dust, debris, moisture, light, etc. A central processing unit (CPU) 132 is configured to execute logic 136 stored in memory 134. Logic 136 is also referred to as program instructions for controlling the image sensor 104, first and second side light sets 106, 108, and sound-generating device 110.

The image sensor 104 includes a corresponding image hardware/software module 140 in the circuitry 130. The image hardware/software module 140 outputs analog/digital data that represents one or more images captured with image sensor 104 of the space and objects in the space located behind the vehicle. The one or more sensors described above can be included as part of image hardware/software module 140. The raw image files produced by the image hardware/software module 140 are output to and processed by an image processor 142. The image processor 142 is configured to crop or resize original images, adjust color and improve image quality, and eliminate visual artifacts.

The first and second side light sets 106, 108, and sound-generating device 110 also include corresponding hardware/software modules 144, 146 that are configured to activate and control the first and second side light sets 106, 108, and sound-generating device 110. The hardware/software modules 144, 146 are also configured to output digital data that represents the illumination status of the lights and the sound produced by the sound-generating device.

The outputs from the image hardware/software module 140 (and image processor 142), light hardware/software module 144, and sound hardware/software module 146 are provided to a communication interface 138. The communication interface 138 is configured to receive signals of the data output from the image hardware/software module 140 (and image processor 142), light hardware/software module 144, and sound hardware/software module 146. The communication interface 138 may include a wireless transceiver and communications components capable of enabling data transmissions to and from the backup-assisting device 100. For example, the communication interface 138 may include a wireless internet network controller (e.g., Wi-Fi) or a Bluetooth transceiver; however, such an embodiment is non-limiting. In embodiments where the communication interface 138 is wireless, the communication interface is also configured to modulate the signals onto a radio frequency carrier and is broadcast as short-range radio frequency signals. Such signals, when received by a mating or corresponding transceiver, are demodulated and recovered in the corresponding transceiver-receiving device. As can be appreciated, the communication interface 138 can also or alternatively be configured to transmit and/or receive data via a wire connection.

The communication interface 138, image hardware/software module 140, image processor 142, light hardware/software module 144, and sound hardware/software module 146 are controlled by CPU 132. The CPU 132, memory 134, logic 136, communication interface 138, image hardware/software module 140, image processor 142, light hardware/software module 144, and sound hardware/software module 146 are coupled via a conventional address/data/control bus 150. The CPU 132 thus effectuates control over the components of the circuitry 130 via bus 150. One or more input-output (“I/O”) devices 152, 154 allow the circuitry 130 to communicate with one or more external computing devices 300, such as smart device or display 302. In one non-limiting arrangement, there is provided a dedicated display 302 that is generally mounted in the vehicle (e.g., dashboard) so that the operator of the vehicle can see images transmitted from the backup-assisting device 100. Such dedicated display can optionally be part of a built-in navigation system of a vehicle or can be a separate display that has been mounted (permanently mounted or temporarily mounted) to the dashboard of an existing vehicle. The dedicated display and/or smart device may also include one or more buttons and/or touch-screen buttons to control other aspects of the backup-assisting device 100 (e.g., turn backup-assisting device on/off, increase illumination of first and/or second side light sets, change color of first and/or second side light sets, activate flashing of first and/or second side light sets, turn on/off first and/or second side light sets, increase/decrease rate of flashing of first and/or second side light sets, store images from image sensor, delete images from image sensor, zoom in/out images from image sensor, move image sensor to see different angles, reduce/increase image size displayed on dedicated display, crop images, play backed-up/stored images, change time, change date, cause images to be time/date stamped, control volume of sound-generating device, control sound frequency of sound-generating device, turn off/on sound-generating device, control the type of sound produced by the sound-generating device, etc.). As can be appreciated, the dedicated display can be substituted for a smart device (e.g., smart phone, tablet, laptop computer, smart watch, etc.). The smart device can be temporarily mounted in the vehicle, placed on the seat next to the user of the vehicle or in some other location such that the user can view the display on the smart device while also operating the vehicle. The external computing devices 300, such as smart device or display 302 can include circuitry that is the same or similar to circuitry 130 and 230. When a smart device is used, the circuitry in the smart device can optionally include GPS devices, voice command devices, motion sensors, and/or other types of components that are available in smart phones (e.g., Galaxy S20+®, iPhone 11 XS®, Samsung Galaxy Note 10 Plus®, OnePlus 8 Pro®, etc.).

The communication interface 138 may optionally send and receive data over a network 156 which can be implemented through, for example, a wireless network such as a wireless local area network (WLAN). Optionally, the communication interface 138 may alternatively send and receive data over physical wiring 160. In any event, data sent or received over network 156 or wiring 160 is sent to or received from an associated vehicle, represented schematically in FIG. 6 by numeral 200.

The circuitry 130 can optionally include other devices such as a GPS device, voice control modules, etc.

Vehicle 200 includes a body 202 to which backup-assisting device 100 is connected via mounting arrangement 114, as discussed in further detail above. The vehicle 200 optionally also includes circuitry 230 configured to trigger activation of and/or receive data from the communication interface 138, image hardware/software module 140, image processor 142, light hardware/software module 144, and sound hardware/software module 146 of backup-assisting device 100. As can be appreciated, circuitry 230 in the vehicle 200 is not required. The wired or wireless signal from the backup-assisting device 100 can be directly transmitted to the one or more external computing devices 300, such as a smart device or dedicated display 302. If circuitry 230 is used, it can be partially or fully included in the one or more external computing devices 300.

When circuitry 230 is used, circuitry 230 includes a CPU 232 that is configured to execute programming instructions or logic 236 stored in memory 234 corresponding to various functions of the vehicle. The circuitry 230 in the vehicle 200 can be included as part of a stand-alone device which is mountable in the interior of the vehicle 200 or can be included as part of a factory-fitted system built into the vehicle 200. Alternatively, the circuitry 230 in the vehicle is included as part of an external computing device 300, such as smart device or dedicated display 302.

The circuitry 230 in vehicle 200 further includes a communication interface 238 similar to interface 138 of circuitry 130 discussed above. Thus, communication interface 238 may include a wireless transceiver and communications components capable of enabling data transmissions to and from the vehicle 200. The communication interface 238 is configured to request, receive, modulate, and/or broadcast signals of the data which can be output from the circuitry 130 of backup-assisting device 100. The communication interface 238 may request and receive data over network 156 or physical wiring 160.

A display device 240 is also included with the circuitry 230 in vehicle 200. The logic 236 is configured to provide a user interface, which may be presented to a driver in vehicle 200 via the display device 240. The display device 240 may be implemented as a panel within a rear-view mirror of the vehicle or may be implemented by a display screen. The display screen can be a stand-alone device adapted to be fixed to a portion of the vehicle interior or can be pre-fitted within the vehicle console (e.g., as part of a navigation or information system). Alternatively, the display device 240 is implemented as a display screen of an external computing device 300, such as dedicated display or smartphone 302. The display device 240 is configured to show the driver of the vehicle images or representations thereof captured by image sensor 104 and image hardware/software module 140 and processed by image processor 142. Moreover, the display device 240 is configured to show representations of the data generated by first and second side light sets 106, 108 with light hardware/software module 144 and sound-generating device 110 with sound hardware/software module 146.

The communication interface 238 and display device 240 are controlled by CPU 232. The CPU 232, memory 234, logic 236, communication interface 238, and display device 240 are coupled via a conventional address/data/control bus 250. The CPU 232 thus effectuates control over the components of the circuitry 230 via bus 250. One or more I/O devices 252, 254 allow the circuitry 230 to communicate with one or more external computing devices 300, such as a dedicated display or smartphone 302. In this regard, the connection over network 156 or physical wiring 160 enables the external computing device 300 to show the driver of the vehicle images or representations thereof generated by the image sensor, illuminating device, and/or sound-generating device.

The circuitry 230 can optionally include other devices such as a GPS device, voice control modules, etc.

During operation of the exemplary backup-assisting device 100 and vehicle 200, the logic 236 is configured to monitor activities through the CPU 232 in the vehicle to identify a triggering event that will cause activation of image sensor 104, first and second side light sets 106/108, and/or sound-generating device 110. Alternatively, the driver of the vehicle 200 can manually activate the backup-assisting device 100 when the driver plans to move the vehicle 200. Manual activation can be by the activating of a button/switch, touch screen, and/or by voice command.

The triggering event may be automatically implemented by logic 236 once the CPU 232 detects that the reverse gear of the vehicle 200 is engaged and/or detects reverse movement of the vehicle 200. In addition, or alternatively, the triggering event may be implemented as 1) a selectable option on the display device 240 via the logic 236 and CPU 232, and/or 2) by a selectable option on the external computing device 300.

Once the triggering event is detected, the communication interface 238 requests the activation of image sensor 104, first and second side light sets 106, 108, and/or sound-generating device 110 over network 156 and/or wiring 160. The communication interface 138 of backup-assisting device 100 receives the request and CPU 132 instructs the activation and operation of hardware/software modules 140, 144, and/or 146 according to logic 136. This request to activate instructs image sensor 104 to begin capturing images and the image hardware/software module 140 to begin generating and recording data related to the image capturing. The activation request also instructs first and/or second side light sets 106/108 to illuminate and the light hardware/software module 144 to begin generating and recording data related to the illumination of the first and/or second side light sets. The activation request may also include control commands for adjusting the intensity of illumination by the first and/or second side light sets 106, 108. The activation request may also instruct the sound-generating device 110 to generate a sound and the sound hardware/software module 146 to begin generating and recording data related to the generation of sound. The activation request may also include control commands for adjusting the volume/frequency/type of the sounds generated by the sound-generating device 110.

The communication interface 138 transmits the data recorded/generated by hardware/software modules 140, 144, and 146 as a live data stream to the communication interface 238 of the vehicle over the network 156 and/or by wiring 160. These transmissions may include the compressing of the data stream for faster communication. Once the data stream from the circuitry 130 of backup-assisting device 100 is transmitted to the vehicle 200, the logic 236 receives the data via the communication interface 238 and renders data to the display device 240. Once data is rendered to the display device 240, the display device displays the data in a way that is meaningful to the driver of the vehicle. As can be appreciated, the data from circuitry 130 may also or alternatively be transmitted to one or more external computing devices 300, such as a dedicated display or smartphone 302.

The backup-assisting device 100 can optionally include a motion sensor that can be used to 1) activate the backup-assisting device when motion and/or an object (e.g., person, pole, rock, structure, tree, wall, etc.) is detected within a certain distance of the backup-assisting device, 2) increase the volume and/or change the frequency and/or type of sound being generated by the sound-generating device when motion and/or an object is detected within a certain distance of the backup-assisting device, and/or 3) increase light intensity and/or change light color and/or change light flashing sequence when motion and/or an object is detected within a certain distance of the backup-assisting device.

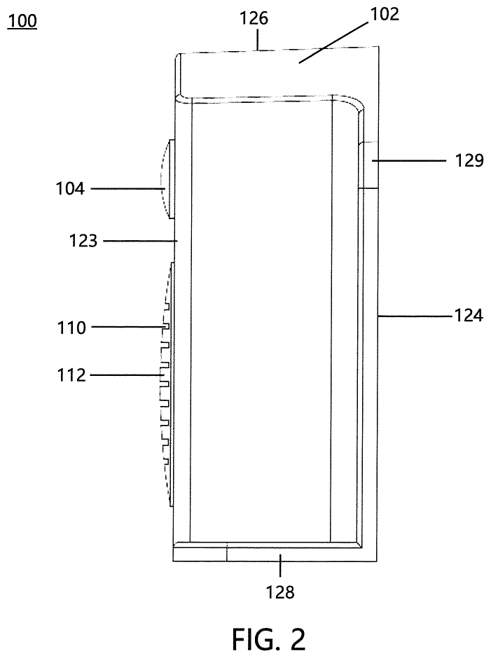

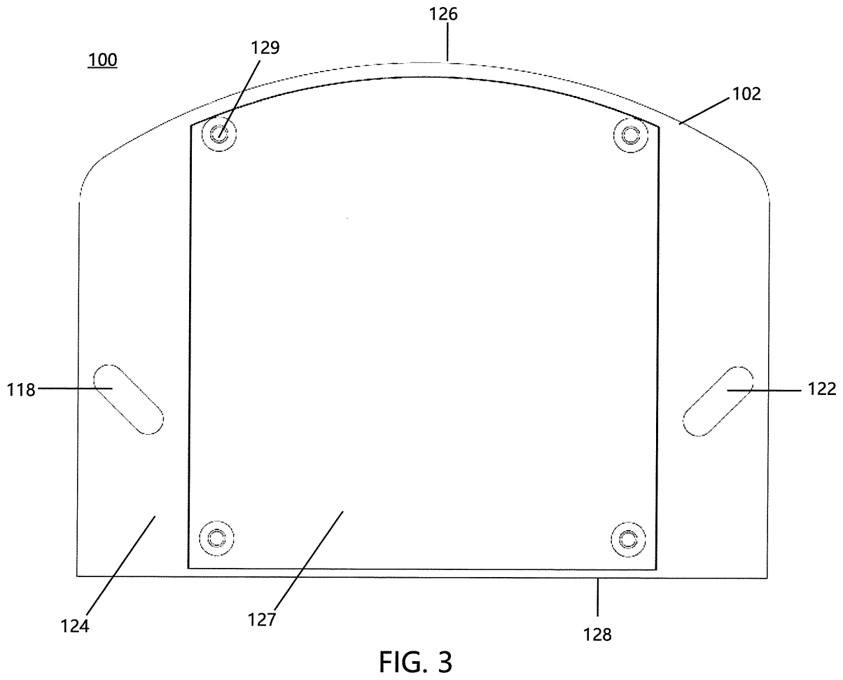

In some embodiments, operating power for the backup-assisting device 100 is provided by the vehicle 200 to which it is attached. In alternate embodiments, power to the backup-assisting device 100 can be supplied by a battery (e.g., 12V battery, etc.) located in or attached to the housing 102. As illustrated in FIGS. 2 and 3, the housing 102 can optionally include a removable panel 127 that can provide access to the internal components of the housing 102. For example, when the housing includes one or more batteries, the removable panel can be removed to allow a user to insert and/or replace the batteries in the housing 102. The removable panel 127 can be secured to the housing by one or more screws 129; however, other attachments arrangements can be used (e.g., latch, snap, etc.).

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

What is claimed:

1. A backup-assisting device configured to be connected to an existing vehicle to assist in the backing up of the vehicle, wherein said backup-assisting device comprises:
a housing, said housing having a front face and a mounting arrangement, said mounting arrangement configured to facilitate in attaching said housing to a rear of the vehicle;
an image sensor, said image sensor configured to capture and/or record images, said image sensor at least partially located on said front face of said housing;
an illuminating device, said illuminating device configured to generate light, said illuminating device at least partially located on said front face of said housing;
a sound-generating device, said sound-generating device configured to generate sound, said sound-generating device at least partially located on said front face of said housing; and,
control circuitry at least partially located in an interior of said housing, said control circuitry including an image hardware/software module, a light hardware/software module, a sound hardware/software module, and a communication interface, said image hardware/software module configured to receive and/or output data that represents one or more images captured and/or recorded by said image sensor, said light hardware/software module configured to activate and/or control said one or more illuminating devices, said sound hardware/software module configured to activate and/or control said sound-generating device, said communication interface configured to send and/or receive data between a remote display and 1) said image hardware/software module, 2) said light hardware/software module, and/or 3) said sound hardware/software module.

2. The backup-assisting device as defined in claim 1, wherein said mounting arrangement includes a first mounting flange on a first side of said housing and a second mounting flange on a second side of said housing, said first mounting flange including one or more opening adapted to receive a bolt or screw or cord, said second mounting flange including one or more opening adapted to receive a bolt or screw or cord.

3. The backup-assisting device as defined in claim 1, wherein said illuminating device includes first and second sets of lights, said first set of lights including a plurality of lights, said second set of lights including a plurality of lights, at least a portion of said image sensor is located between said first and second sets of lights.

4. The backup-assisting device as defined in claim 2, wherein said illuminating device includes first and second sets of lights, said first set of lights including a plurality of lights, said second set of lights including a plurality of lights, at least a portion of said image sensor is located between said first and second sets of lights.

5. The backup-assisting device as defined in claim 1, wherein said housing includes a removable back panel, said removable back panel providing access to a battery compartment in an interior of said housing.

6. The backup-assisting device as defined in claim 4, wherein said housing includes a removable back panel, said removable back panel providing access to a battery compartment in an interior of said housing.

7. The backup-assisting device as defined in claim 1, wherein said communication interface includes a wireless transmitter and wireless receiver to wirelessly transmit data to and receive data from said remote display.

8. The backup-assisting device as defined in claim 6, wherein said communication interface includes a wireless transmitter and wireless receiver to wirelessly transmit data to and receive data from said remote display.

9. A backup-assisting system configured to be connected to an existing vehicle to assist in the backing up of the vehicle, wherein said backup-assisting system comprises:
a backup-assisting device comprising:
a housing, said housing having a front face and a mounting arrangement, said mounting arrangement configured to facilitate in attaching said housing to a rear of the vehicle;
an image sensor, said image sensor configured to capture and/or record images, said image sensor at least partially located on said front face of said housing;
an illuminating device, said illuminating device configured to generate light, said illuminating device at least partially located on said front face of said housing;
a sound-generating device, said sound-generating device configured to generate sound, said sound-generating device at least partially located on said front face of said housing; and,
control circuitry at least partially located in an interior of said housing, said control circuitry including an image hardware/software module, a light hardware/software module, a sound hardware/software module, and a communication interface, said image hardware/software module configured to receive and/or output data that represents one or more images captured and/or recorded by said image sensor, said light hardware/software module configured to activate and/or control said one or more illuminating devices, said sound hardware/software module configured to activate and/or control said sound-generating device, said communication interface configured to send and/or receive data from 1) said image hardware/software module, 2) said light hardware/software module, and/or 3) said sound hardware/software module; and,
an external device that is located remotely of said housing of said backup-assisting device, said external device including a display to display images that were captured and/or recorded by said image sensor of said backup-assisting device, said external device including communication circuitry configured to received data from and/or transmit data to said communication interface communication interface of said backup-assisting device.

10. The backup-assisting system as defined in claim 9, wherein said external device is a device selected from the group consisting of a smart phone, a tablet, a laptop computer, an integrated display in the front dashboard of the vehicle, and a free standing display.

11. The backup-assisting system as defined in claim 9, wherein said mounting arrangement includes a first mounting flange on a first side of said housing and a second mounting flange on a second side of said housing, said first mounting flange including one or more opening adapted to receive a bolt or screw or cord, said second mounting flange including one or more opening adapted to receive a bolt or screw or cord.

12. The backup-assisting system as defined in claim 9, wherein said illuminating device includes first and second sets of lights, said first set of lights including a plurality of lights, said second set of lights including a plurality of lights, at least a portion of said image sensor is located between said first and second sets of lights.

13. The backup-assisting system as defined in claim 9, wherein each of said communication interface and said external device include a separate wireless transmitter and wireless receiver to wirelessly transmit data to and receive data from said external device and said backup-assisting device.

14. The backup-assisting system as defined in claim 9, wherein said control circuitry of said backup-assisting device is in communication with circuitry of the vehicle so that said control circuitry of said backup-assisting device is able to detect when said vehicle is moving in a reverse direction and/or has shifted into reverse gear, and wherein said control circuitry of said backup-assisting device is configured to activate said image sensor, said illuminating device, and/or said sound-generating device when said control circuitry of said backup-assisting device detects said vehicle moving in the reverse direction and/or has shifted into reverse gear.

15. A method for assisting a user of a vehicle in the backing up of said vehicle, said method comprises:
providing said vehicle, said vehicle having a rear portion
providing a backup-assisting device, said backup-assisting device comprising:
a housing, said housing having a front face and a mounting arrangement, said mounting arrangement configured to facilitate in attaching said housing to said rear portion of said vehicle;
an image sensor, said image sensor configured to capture and/or record images, said image sensor at least partially located on said front face of said housing;
an illuminating device, said illuminating device configured to generate light, said illuminating device at least partially located on said front face of said housing;
a sound-generating device, said sound-generating device configured to generate sound, said sound-generating device at least partially located on said front face of said housing; and,
control circuitry at least partially located in an interior of said housing, said control circuitry including an image hardware/software module, a light hardware/software module, a sound hardware/software module, and a communication interface, said image hardware/software module configured to receive and/or output data that represents one or more images captured and/or recorded by said image sensor, said light hardware/software module configured to activate and/or control said one or more illuminating devices, said sound hardware/software module configured to activate and/or control said sound-generating device, said communication interface configured to send and/or receive data from 1) said image hardware/software module, 2) said light hardware/software module, and/or 3) said sound hardware/software module;
providing an external device that is located remotely of said housing of said backup-assisting device, said external device including a display that is configured to display images that were captured and/or recorded by said image sensor of said backup-assisting device, said external device including communication circuitry configured to received data from and/or transmit data to said communication interface communication interface of said backup-assisting device;
connecting said housing of said backup-assisting device to said rear portion of said vehicle;
activating said backup-assisting device prior to, during, or after said vehicle is moving in the reverse direction or has shifted into reverse gear, said activating said backup-assisting device causing a) activation of said image sensor, and optional activation of said illuminating device and/or said sound-generating device, and b) transmission of data from said image sensor to said external device; and,
displaying images on said display of said external device that are viewable in real-time by a user of said vehicle after said step of activating said backup-assisting device while said user is operating said vehicle.

16. The method as defined in claim 15, wherein said external device is a device selected from the group consisting of a smart phone, a tablet, a laptop computer, an integrated display in the front dashboard of the vehicle, and a free standing display.

17. The method as defined in claim 15, wherein said illuminating device includes first and second sets of lights, said first set of lights including a plurality of lights, said second set of lights including a plurality of lights, at least a portion of said image sensor is located between said first and second sets of lights.

18. The method as defined in claim 15, wherein each of said communication interface and said external device include a separate wireless transmitter and wireless receiver to wirelessly transmit data to and receive data from said external device and said backup-assisting device.

19. The method as defined in claim 15, wherein said control circuitry of said backup-assisting device is in communication with control circuitry of the vehicle so that said control circuitry of said backup-assisting device is able to detect when said vehicle is moving in a reverse direction and/or has shifted into reverse gear, and wherein said control circuitry of said backup-assisting device is configured to activate said an image sensor, said illuminating device, and/or said sound-generating device when said control circuitry of said backup-assisting device detects said vehicle moving in the reverse direction and/or has shifted into reverse gear.

20. The method as defined in claim 15, wherein said external device includes a microphone to enable said user to speak into said microphone and to broadcast such speech through said sound-generating device of said backup-assisting device.
